(19) United States
(12) Patent Application Publication
(10) Pub. No.: US 2025/0185023 A1
(43) Pub. Date: Jun. 5, 2025

(54) MULTIPLE CARRIER SCHEDULING VIA SINGLE DOWNLINK CONTROL INFORMATION TRANSMISSIONS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/959,559

(22) Filed: Nov. 25, 2024

Related U.S. Application Data
(60) Provisional application No. 63/605,321, filed on Dec. 1, 2023.

(51) Int. Cl. H04W 72/232; H04L 1/08; H04W 72/12; H04W 72/542

(52) U.S. Cl. CPC H04W 72/232; H04L 1/08; H04W 72/12; H04W 72/542

(57) ABSTRACT

Methods, systems, and devices for wireless communications are described that provide for signaling from a network entity to a user equipment (UE) that indicates a pattern for a single downlink control information (DCI) transmission that provides scheduling information for multiple carriers. The pattern may provide two or more repetitions of the single DCI, where a quantity of repetitions, an identity or quantity of carriers over which the DCI is transmitted, or combinations thereof, may be based on a size of the DCI. The UE also may perform control channel receive quality measurements and prediction on each carrier for different DCI sizes and provide feedback to the network entity on which carrier has highest likelihood of successful DCI reception for possible DCI size ranges, which the network entity may use to determine which carriers use for DCI, an aggregation level, a transmit power, beamforming parameters, or any combinations thereof.

### CROSS REFERENCE

The present Application for Patent claims the benefit of U.S. Provisional Patent Application No. 63/605,321 by YANG et al., entitled “MULTIPLE CARRIER SCHEDULING VIA SINGLE DOWNLINK CONTROL INFORMATION TRANSMISSIONS,” filed Dec. 1, 2023, assigned to the assignee hereof, and expressly incorporated by reference herein.

### FIELD OF TECHNOLOGY

The following relates to wireless communications, including multiple carrier scheduling via single downlink control information transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multiple carrier scheduling via single downlink control information (DCI) transmissions. For example, the described techniques provide for signaling from a network entity to a user equipment (UE) that indicates a pattern for a single DCI that provides scheduling information for multiple carriers. In some aspects, the pattern may provide two or more repetitions of the single DCI, where a quantity of repetitions, a quantity of carriers over which the DCI is transmitted, or both, may be based on a size of the DCI. In some aspects, the UE may perform control channel receive quality measurements on each carrier and provide feedback to the network entity on which carrier has a highest likelihood of successful DCI reception, which the network entity may use to determine which carriers use for DCI, an aggregation level, a transmit power, beamforming parameters, or any combinations thereof.

A method for wireless communications by a user equipment (UE) is described. The method may include receiving configuration information for a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted, monitoring the one or more scheduling carriers of the set of multiple carriers for one or more repetitions of the single downlink control information communication in accordance with the carrier pattern, and receiving scheduling information for the set of multiple carriers in the single downlink control information communication.

A UE for wireless communications is described. The UE may include one or more memories storing processor executable code, and one or more processors coupled with the one or more memories. The one or more processors may individually or collectively operable to execute the code to cause the UE to receive configuration information for a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted, monitor the one or more scheduling carriers of the set of multiple carriers for one or more repetitions of the single downlink control information communication in accordance with the carrier pattern, and receive scheduling information for the set of multiple carriers in the single downlink control information communication.

Another UE for wireless communications is described. The UE may include means for receiving configuration information for a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted, means for monitoring the one or more scheduling carriers of the set of multiple carriers for one or more repetitions of the single downlink control information communication in accordance with the carrier pattern, and means for receiving scheduling information for the set of multiple carriers in the single downlink control information communication.

A non-transitory computer-readable medium storing code for wireless communications is described. The code may include instructions executable by one or more processors to receive configuration information for a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted, monitor the one or more scheduling carriers of the set of multiple carriers for one or more repetitions of the single downlink control information communication in accordance with the carrier pattern, and receive scheduling information for the set of multiple carriers in the single downlink control information communication.

Some examples of the method, UEs, and non-transitory computer-readable medium described herein may further include operations, features, means, or instructions for transmitting a receive scheduling control channel quality measurement and prediction for each carrier of the set of multiple carriers that indicates a channel quality associated with each respective carrier of the set of multiple carriers. In some examples of the method, UEs, and non-transitory computer-readable medium described herein, the receive scheduling control channel quality measurement and prediction for each carrier of the set of multiple carriers includes a probability of unsuccessful receipt of the single downlink control information communication at the UE for one or more control information payload size ranges. In some examples of the method, UEs, and non-transitory computer-readable medium described herein, the receive scheduling control channel quality measurement and prediction for each carrier of the set of multiple carriers may be transmitted via a scheduling control channel state information (CSI) report, a medium access control (MAC) control element (CE), or any combinations thereof.

Some examples of the method, UEs, and non-transitory computer-readable medium described herein may further include operations, features, means, or instructions for receiving updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.

Some examples of the method, UEs, and non-transitory computer-readable medium described herein may further include operations, features, means, or instructions for transmitting a capability indication that indicates that the UE is capable of receiving and predicting scheduling information receive performance for each carrier of the set of multiple carriers in the single downlink control information communication. In some examples of the method, UEs, and non-transitory computer-readable medium described herein, the capability indication provides separate indications for each of two or more frequency bands.

In some examples of the method, UEs, and non-transitory computer-readable medium described herein, the carrier pattern indicates a quantity of repetitions of the single downlink control information communication for each carrier of the set of multiple carriers. In some examples of the method, UEs, and non-transitory computer-readable medium described herein, different carriers of the set of multiple carriers may have different quantities of repetitions of the single downlink control information communication. In some examples of the method, UEs, and non-transitory computer-readable medium described herein, the carrier pattern further indicates two or more different downlink slots for two or more repetitions of the single downlink control information communication.

Some examples of the method, UEs, and non-transitory computer-readable medium described herein may further include operations, features, means, or instructions for transmitting a control channel reception statistics report that indicates a quality of control channel communications that have been received at the UE for each carrier of the set of multiple carriers. In some examples of the method, UEs, and non-transitory computer-readable medium described herein, the control channel reception statistics report may be transmitted via a scheduling control CSI report, a MAC-CE, or any combinations thereof. Some examples of the method, UEs, and non-transitory computer-readable medium described herein may further include operations, features, means, or instructions for predicting a control channel reception performance that indicates an expected quality of control channel communications for each carrier of the plurality of carriers.

Some examples of the method, UEs, and non-transitory computer-readable medium described herein may further include operations, features, means, or instructions for receiving, responsive to the control channel reception statistics report, updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.

In some examples of the method, UEs, and non-transitory computer-readable medium described herein, the one or more scheduling carriers may be determined based on one or more reference signal transmissions from the UE, a discontinuous transmission (DTX) configuration of the UE, a block error rate for each carrier of the set of multiple carriers, or any combinations thereof.

A method for wireless communications by a network entity is described. The method may include outputting configuration information for a UE that configures a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted and outputting one or more repetitions of the single downlink control information communication on the one or more scheduling carriers of the set of multiple carriers in accordance with the carrier pattern.

A network entity for wireless communications is described. The network entity may include one or more memories storing processor executable code, and one or more processors coupled with the one or more memories. The one or more processors may individually or collectively operable to execute the code to cause the network entity to output configuration information for a UE that configures a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted and output one or more repetitions of the single downlink control information communication on the one or more scheduling carriers of the set of multiple carriers in accordance with the carrier pattern.

Another network entity for wireless communications is described. The network entity may include means for outputting configuration information for a UE that configures a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted and means for outputting one or more repetitions of the single downlink control information communication on the one or more scheduling carriers of the set of multiple carriers in accordance with the carrier pattern.

A non-transitory computer-readable medium storing code for wireless communications is described. The code may include instructions executable by one or more processors to output configuration information for a UE that configures a single downlink control information communication that provides scheduling information for each carrier of a set of multiple carriers, the configuration information including a carrier pattern that indicates a quantity of repetitions of the single downlink control information communication and one or more scheduling carriers of the set of multiple carriers over which the quantity of repetitions of the single downlink control information communication will be transmitted and output one or more repetitions of the single downlink control information communication on the one or more scheduling carriers of the set of multiple carriers in accordance with the carrier pattern.

Some examples of the method, network entities, and non-transitory computer-readable medium described herein may further include operations, features, means, or instructions for obtaining, from the UE, a receive scheduling control channel quality measurement and prediction for each carrier of the set of multiple carriers that indicates a channel quality associated with each respective carrier of the set of multiple carriers. In some examples of the method, network entities, and non-transitory computer-readable medium described herein, the receive scheduling control channel quality measurement and prediction for each carrier of the set of multiple carriers includes a probability of unsuccessful receipt of the single downlink control information communication at the UE for one or more control information payload size ranges. In some examples of the method, network entities, and non-transitory computer-readable medium described herein, the receive quality scheduling control channel measurement for each carrier of the set of multiple carriers may be transmitted via a scheduling control CSI report, a MAC-CE, or any combinations thereof.

Some examples of the method, network entities, and non-transitory computer-readable medium described herein may further include operations, features, means, or instructions for outputting updated configuration information that updates, based on the receive quality measurement for each carrier, the one or more scheduling carriers, the quantity of repetitions of the single downlink control information communication, a transmit power of one or more repetitions the single downlink control information communication, one or more beamforming parameters used to transmit one or more repetitions of the single downlink control information communication, or any combinations thereof.

Some examples of the method, network entities, and non-transitory computer-readable medium described herein may further include operations, features, means, or instructions for obtaining, from the UE, a capability indication that indicates that the UE is capable of receiving and predicting scheduling information receive performance for each carrier of the set of multiple carriers in the single downlink control information communication. In some examples of the method, network entities, and non-transitory computer-readable medium described herein, the capability indication provides separate indications for each of two or more frequency bands. In some examples of the method, network entities, and non-transitory computer-readable medium described herein, the carrier pattern indicates a quantity of repetitions of the single downlink control information communication for each carrier of the set of multiple carriers.

In some examples of the method, network entities, and non-transitory computer-readable medium described herein, different carriers of the set of multiple carriers may have different quantities of repetitions of the single downlink control information communication. In some examples of the method, network entities, and non-transitory computer-readable medium described herein, the carrier pattern further indicates two or more different downlink slots for two or more repetitions of the single downlink control information communication.

Some examples of the method, network entities, and non-transitory computer-readable medium described herein may further include operations, features, means, or instructions for obtaining, from the UE, a control channel reception statistics report that indicates a quality of control channel communications that have been received at the UE for each carrier of the set of multiple carriers. In some examples of the method, network entities, and non-transitory computer-readable medium described herein, the control channel reception statistics report may be transmitted via a scheduling control CSI report, a MAC-CE, or any combinations thereof.

Some examples of the method, network entities, and non-transitory computer-readable medium described herein may further include operations, features, means, or instructions for outputting, responsive to the control channel reception statistics report, updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.

In some examples of the method, network entities, and non-transitory computer-readable medium described herein, the one or more scheduling carriers may be determined based on one or more reference signal transmissions from the UE, a DTX configuration of the UE, a block error rate for each carrier of the set of multiple carriers, or any combinations thereof.

### BRIEF DESCRIPTION OF THE DRAWINGS

FIG. 1 shows an example of a wireless communications system that supports multiple carrier scheduling via single downlink control information (DCI) transmissions in accordance with one or more aspects of the present disclosure.

FIG. 2 shows an example of a wireless communications system that supports multiple carrier scheduling via single DCI transmissions in accordance with one or more aspects of the present disclosure.

FIG. 3 shows an example of multiple carrier scheduling via a single DCI transmission in accordance with one or more aspects of the present disclosure.

FIG. 4 shows an example of a process flow that supports multiple carrier scheduling via single DCI transmissions in accordance with one or more aspects of the present disclosure.

FIGS. 5 and 6 show block diagrams of devices that support multiple carrier scheduling via single DCI transmissions in accordance with one or more aspects of the present disclosure.

FIG. 7 shows a block diagram of a communications manager that supports multiple carrier scheduling via single DCI transmissions in accordance with one or more aspects of the present disclosure.

FIG. 8 shows a diagram of a system including a device that supports multiple carrier scheduling via single DCI transmissions in accordance with one or more aspects of the present disclosure.

FIGS. 9 and 10 show block diagrams of devices that support multiple carrier scheduling via single DCI transmissions in accordance with one or more aspects of the present disclosure.

FIG. 11 shows a block diagram of a communications manager that supports multiple carrier scheduling via single DCI transmissions in accordance with one or more aspects of the present disclosure.

FIG. 12 shows a diagram of a system including a device that supports multiple carrier scheduling via single DCI transmissions in accordance with one or more aspects of the present disclosure.

FIGS. 13 through 19 show flowcharts illustrating methods that support multiple carrier scheduling via single DCI transmissions in accordance with one or more aspects of the present disclosure.

### DETAILED DESCRIPTION

A wireless communications system may include a device, such as a user equipment (UE) or a network entity (e.g., an eNodeB (eNB), a next-generation NodeB or a giga-NodeB, either of which may be referred to as a gNB, or some other base station or network entity), that supports wireless communications using one or multiple radio access technologies. Examples of radio access technologies include 4G systems, such as LTE systems, 5G systems, which may be referred to as new radio (NR) systems, or other systems and radio technologies, including future systems and radio technologies not explicitly mentioned herein (e.g., sixth generation (6G) systems and beyond).

In some wireless communications systems, UEs may be configured with multiple carriers, or cells, over which the UE may concurrently communicate with one or more network entities. In some deployments, each carrier may separately carry its associated scheduling information. In other deployments, one carrier may carry scheduling information for other carriers, in which separate downlink control information (DCI) transmissions provide separate resource allocations for each carrier. In still other deployments, one carrier may carry scheduling information for other carriers, in which a single DCI transmission may provide resource allocations for each carrier. In cases where separate DCIs are provided for scheduling each carrier, such techniques can increase overhead and cause a receiving UE to have to decode multiple DCIs, which may involve multiple decoding attempts to determine if a DCI is intended for the UE. In cases where a single DCI provides scheduling information for multiple carriers, the single DCI may be relatively large which may increase the probability that the DCI is not successfully received at the UE. For example, bit errors in the decoded DCI may result in a cyclic redundancy check (CRC) failure at the UE, and such bit errors may be more likely as the number of bits in the DCI increases. Thus, while a single DCI that provides scheduling information for multiple carriers may provide efficiencies (e.g., by reducing a number of blind decodes performed at a UE), it may also result in reduced likelihood of successful reception. Further, a failed decoding of a DCI that schedules multiple carriers may result in a loss of scheduling information for all of the scheduled carriers, which may cause a relatively significant increase in latency for the associated communications. Thus, techniques to increase the reliability for DCI transmissions that schedule multiple carriers may help enhance the efficiency and reliability of wireless communications.

In accordance with various aspects discussed herein, techniques are provided for scheduling of multiple carriers using a single DCI. In some aspects, a UE can indicate capability to support single DCI selection for multiple carrier scheduling, and a network entity can provide signaling (e.g., radio resource control (RRC) signaling, a medium access control (MAC) control element (CE), DCI, or any combinations thereof) that indicates a pattern for a single DCI that provides scheduling for multiple carriers. In some cases, the pattern may provide two or more repetitions of the single DCI, which may increase the likelihood of successful receipt at the UE. In some aspects, a quantity of repetitions, a quantity of carriers over which the DCI is transmitted, or both, may be based on a size of the DCI (e.g., a smaller DCI may have fewer repetitions than a larger DCI, such that both have about the same likelihood of success). Further, in some aspects, the UE may perform receive scheduling control channel quality measurements for each carrier of the multiple carriers, and provide feedback to the network entity on which carrier has highest likelihood of successful DCI reception. The network entity may use this information to determine which carrier(s) to use for DCI, an aggregation level, a transmit power, beamforming parameters, or any combinations thereof.

Various techniques as discussed herein may provide one or more UE and network enhancements and efficiencies. For example, latency may be reduced for communications by enhancing the reliability of DCI communications that schedule multiple carriers. Further, techniques discussed herein allow for adaptive selection and adjustment of carrier and aggregation level for single DCIs that provide multiple carrier scheduling, which may reduce the likelihood of a UE missing a DCI, may avoid throughput losses associated with missed DCIs, and may avoid latency increase associated with missed DCIs.

Aspects of the disclosure are initially described in the context of wireless communications systems. Aspects of the disclosure are further illustrated by and described with reference to scheduling diagrams, process flows, apparatus diagrams, system diagrams, and flowcharts that relate to multiple carrier scheduling via single DCI transmissions.

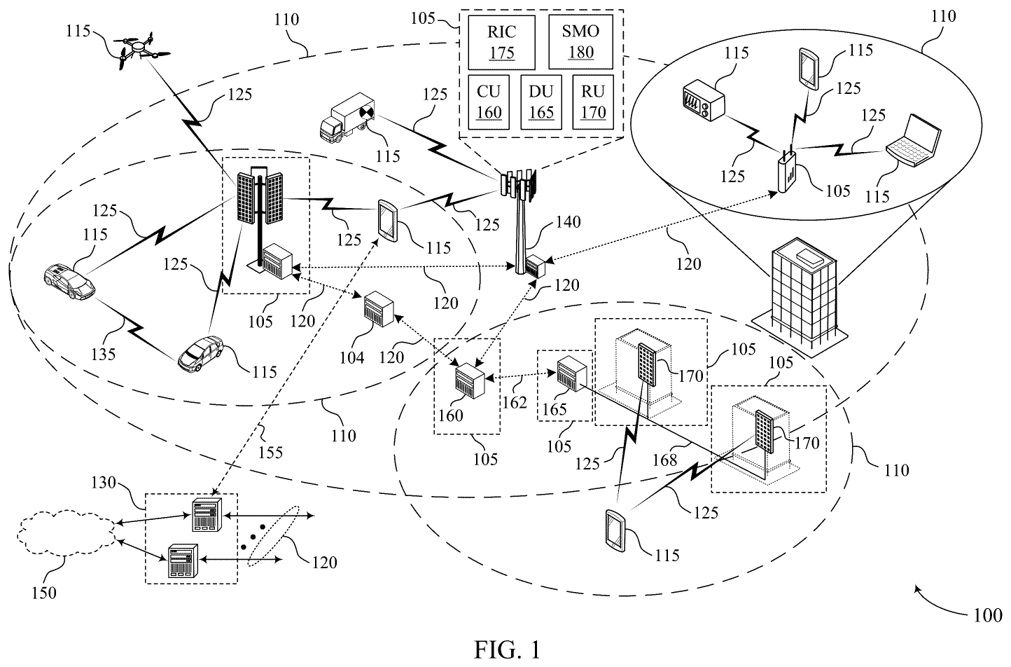

FIG. 1 shows an example of a wireless communications system 100 that supports multiple carrier scheduling via single DCI transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support multiple carrier scheduling via single DCI transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, a network entity 105 may provide scheduling information for multiple carriers to a UE 115 using a single DCI. In some cases, the scheduling information may indicate a pattern for the single DCI that may provide two or more repetitions of the single DCI, where a number of repetitions, a number of carriers over which the DCI is transmitted, or both, may be based on a size of the DCI. In some aspects, a UE 115 may perform control channel receive quality measurements on each of multiple carriers and provide feedback to the network entity 105 on which carrier has highest likelihood of successful DCI reception, which the network entity 105 may then use to determine which carriers use for DCI, an aggregation level, a transmit power, beamforming parameters, or any combinations thereof.

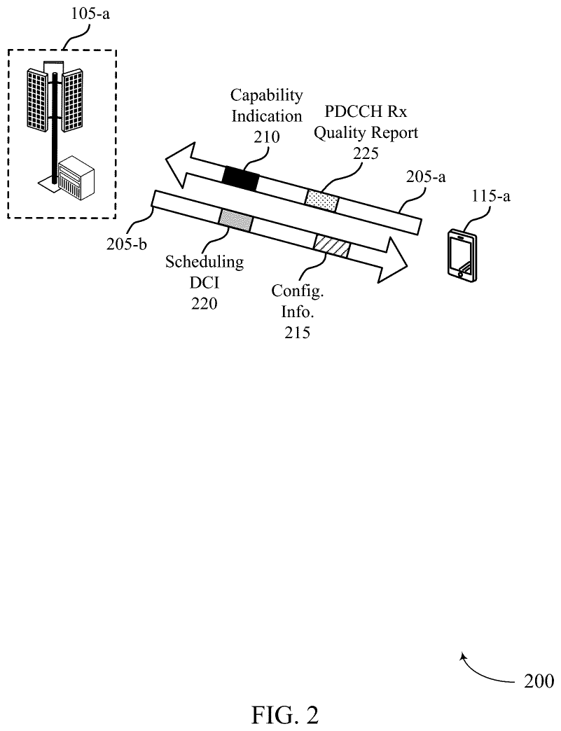

FIG. 2 shows an example of a wireless communications system 200 that supports multiple carrier scheduling via single DCI transmissions in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of a network entity 105 (e.g., an RU 170, a DU 165, a CU 160, a base station 140, or some combination thereof) and a UE 115 as described with reference to FIG. 1.

The network entity 105-a and the UE 115-a may communicate with one another via an uplink channel 205-a and a downlink channel 205-b, which may be examples or components of a communication link 125 as described with reference to FIG. 1. The UE 115-a and network entity 105-a may support techniques for providing multiple carrier scheduling via single DCI transmissions. By providing techniques for multiple carrier scheduling via single DCI transmissions, the UE 115-a and network entity 105-a may promote resource efficiency, reduced latency, and enhanced reliability.

In the example of FIG. 2, the UE 115-a may transmit a capability indication 210 to the network entity 105-a that may indicate a capability to support single DCI selection for multiple carrier scheduling. In some aspects, the capability indication may be provided in one or more UE 115-a capability communications provided to the network entity 105-a via RRC signaling, in one or more MAC-CEs, or any combinations thereof. The network entity 105-a may receive the capability indication 210 and configure a pattern for single DCI transmissions that schedule multiple carriers, which may be transmitted to UE 115-a in configuration information 215. In some aspects, the pattern may provide two or more repetitions of the single DCI, where a number of repetitions, a number of carriers over which the DCI is transmitted, or both, may be based on a size of the DCI. The network entity 105-a may transmit one or more repetitions of scheduling DCI 220 in accordance with the configured pattern. In some aspects, the UE 115-a may perform quality measurements (e.g., reference signal received power (RSRP) measurements, reference signal received quality (RSRQ) measurements, etc.) on each receive scheduling control channel for each carrier of the multiple carriers, and provide feedback in a PDCCH receive channel quality report 225 that is transmitted to the network entity 105-a. The PDCCH receive channel quality report 225, in some aspects, may indicate which carrier of the multiple carriers has a highest likelihood of successful DCI reception, which the network entity 105-a may then use to determine which carriers to use for the scheduling DCI 220, an aggregation level, a transmit power, beamforming parameters, or any combinations thereof.

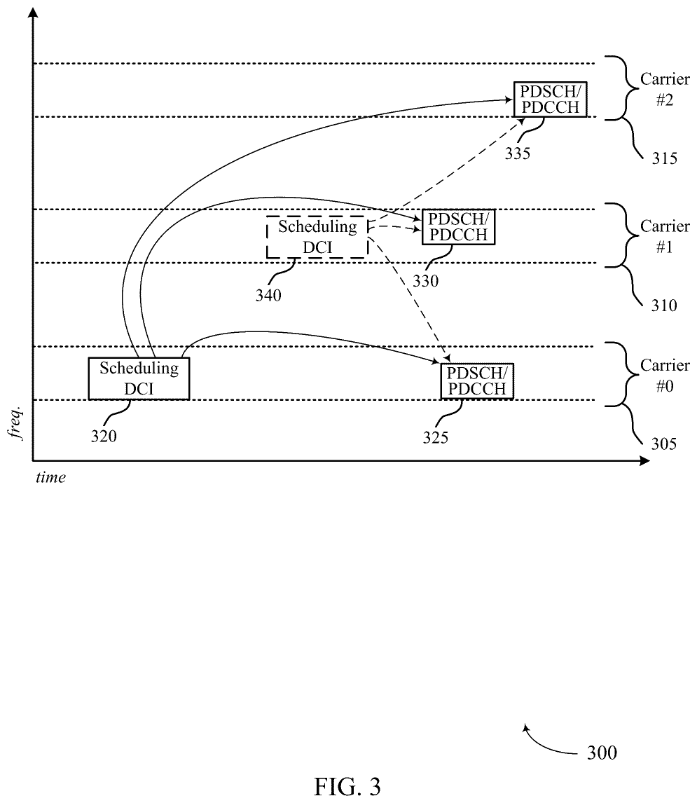

FIG. 3 shows an example of a multi-carrier scheduling 300 that supports multiple carrier scheduling via single DCI transmissions in accordance with one or more aspects of the present disclosure. The multi-carrier scheduling 300 may be implemented by aspects of the wireless communications system 100 or 200. For example, UEs 115 and network entities 105 may implement multi-carrier scheduling using one or more repetitions of a single DCI via a carrier that is selected based on a probability of successful reception of the single DCI at the UE.

In the example of FIG. 3, three carriers may be configured (e.g., for three cells), including a first carrier 305 (e.g., carrier #0), a second carrier 310 (e.g., carrier #1), and a third carrier 315 (e.g., carrier #2), that each occupy different frequencies. In this example, a network entity may transmit a first repetition of a scheduling DCI 320 on the first carrier 305. The scheduling DCI 320 may provide scheduling information for a first communication 325 (e.g., a physical downlink shared channel (PDSCH) transmission, a physical downlink control channel (PDCCH) transmission, or both) on the first carrier 305, a second communication 330 (e.g., a PDSCH/PDCCH transmission) on the second carrier 310, and a third communication 335 (e.g., a PDSCH/PDCCH transmission) on the third carrier 315.

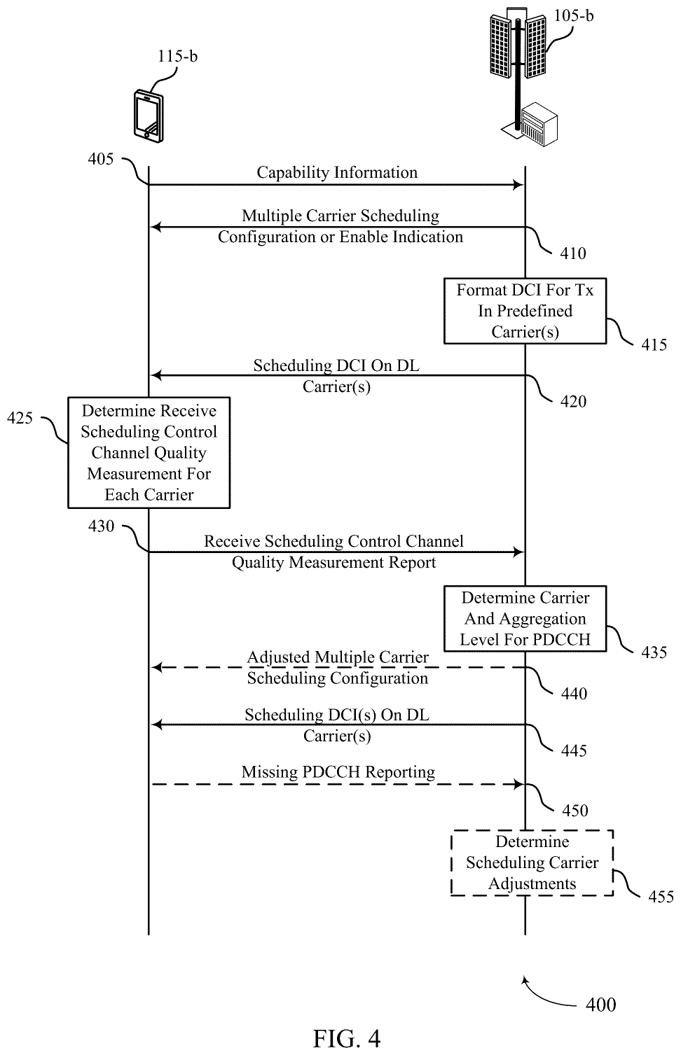

Further, in the example of FIG. 3, a second repetition of the scheduling DCI 340 may be transmitted on the second carrier 310 in different time resources (e.g., a different slot) than the first repetition of the scheduling DCI 320. The second repetition of the scheduling DCI 340 also may provide scheduling information for the first communication 325 on the first carrier 305, the second communication 330 on the second carrier 310, and the third communication 335 on the third carrier 315. As discussed herein, in some aspects the pattern for the first repetition of the scheduling DCI 320 and the second repetition of the scheduling DCI 340 may be provided by a network entity, and a UE may monitor for DCI on one or more carriers in accordance with the indicated pattern. Further, the selection of which carrier (or carriers) to carry the DCI may be performed based on which carrier (or carriers) of the multiple carriers has a higher likelihood of providing for a successful reception of the DCI. In some aspects, the selection of the one or more carriers to carry the DCI may be based on information provided by the UE. FIG. 4 discusses an example of such carrier selection.

FIG. 4 shows an example of a process flow 400 that supports multiple carrier scheduling via single DCI transmissions in accordance with one or more aspects of the present disclosure. The process flow 400 may include a network entity 105-b and a UE 115-b, which may be examples of a network entity 105 and a UE 115 as described with reference to FIGS. 1 through 3. The process flow 400 may be implemented by the network entity 105-b and the UE 115-b where scheduling of multiple carriers using a single DCI may be used by the UE 115-b and network entity 105-b. Such techniques may provide for enhanced reliability and latency reductions associated with multi-carrier scheduling, which may thereby enhance overall network efficiency and user experience. In the following description of the process flow 400, the operations between the network entity 105-b and the UE 115-b may be performed in a different order than the example order shown. Some operations may be omitted from the process flow 400, and other operations may be added to the process flow 400.

At 405, the UE 115-b may transmit a capability information message that indicates to the network entity 105-b a capability of the UE 115-b for carrier selection for multiple carrier scheduling with a single DCI. In some cases, the capability information message may be transmitted via RRC signaling, one or more MAC-CEs, uplink control information (UCI), or any combinations thereof. In some cases, the capability information message may provide separate indications for each of two or more frequency bands (e.g., the UE 115-b may support multiple carrier scheduling with a single DCI for carriers within a first frequency band, and may not support multiple carrier scheduling with a single DCI for carriers within a second frequency band or for different carriers that are in different frequency bands).

At 410, the network entity 105-b may transmit, and the UE 115-b may receive, a multiple carrier scheduling configuration or enable indication. In some aspects, the multiple carrier scheduling configuration or enable indication may provide a pattern for one or more repetitions of a DCI that schedules multiple carriers. In some cases, the multiple carrier scheduling configuration or enable indication may be transmitted via RRC signaling, one or more MAC-CEs, DCI, or any combinations thereof. For example, the single DCI may be transmitted using a defined carrier pattern, such as one DCI for a first carrier, one DCI for a second carrier, and one DCI for a third carrier, or such as three repetitions of the DCI on the first carrier, one repetition of the DCI for a second carrier, and one repetition of the DCI for a third carrier. Numerous different patterns of carriers and repetitions for a scheduling DCI may be used and are within the scope of this disclosure, and the examples herein are provided for purposes of discussion and illustration only.

At 415, the network entity 105-b may format a single DCI that schedules multiple carriers for transmission using one or more carriers in accordance with the multiple carrier scheduling configuration or enable indication. At 420, the network entity 105-b may transmit, and the UE 115-b may receive, one or more repetitions of a scheduling DCI on one or more downlink carriers and in one or more slots as indicated by the pattern provided in the multiple carrier scheduling configuration or enable indication.

At 425, the UE may determine receive scheduling control channel quality measurements for each carrier that provides the scheduling DCI. For example, the UE 115-b may perform PDCCH receive quality measurements on each carrier (e.g., the first carrier, the second carrier, and the third carrier) and report the quality measurements for PDCCH on each carrier. Further, in some aspects, the UE 115-b may predict a likelihood of missing a scheduling DCI on each carrier and provide the predicted chance or probability with the measurement information. In some cases, the predicted likelihood of missing the scheduling DCI may be indicated for two or more different payload size ranges.

At 430, the UE 115-b may transmit, and the network entity 105-b may receive, a receive scheduling control channel quality measurement report that provides the measurements obtained at the UE 115-b and predicted likelihood of missing scheduled DCIs. In some aspects, the receive scheduling control channel quality measurement report may be transmitted in UCI or a MAC-CE using a report format that is defined for providing such control channel quality measurements. For example, the report may be provided via an enhanced channel state information (CSI) report, or a MAC-CE.

At 435, the network entity 105-b may determine which carrier or carriers, and an aggregation level for each carrier, to be used for transmission of one or more subsequent scheduling DCIs. At 440, optionally, the network entity 105-b may transmit, and the UE 115-b may receive, an adjusted multiple carrier scheduling configuration that provides an updated pattern and repetition level for scheduling DCIs for multiple carriers. For example, the network entity 105-b may adjust a scheduling carrier or aggregation level, may adjust a transmit power for the scheduling DCIs, may adjust one or more beamforming parameter such as a beam width or beam direction, or any combinations thereof. In some aspects, the network entity 105-b may also determine a scheduling carrier for transmission of the scheduling DCI based on CSI or sounding reference signal (SRS) measurements, a PUSCH discontinuous transmission (DTX) state, a PDSCH block error rate (BLER) on each carrier, or any combinations thereof.

At 445, the network entity 105-b may transmit, and the UE 115-b may receive, one or more repetitions of a scheduling DCI on one or more downlink carriers, in accordance with the updated pattern and repetition level.

At 450, optionally, the UE 115-b may transmit, and the network entity 105-b may receive, a report of missing PDCCH receptions. At 455, optionally, the network entity 105-b may determine one or more scheduling carrier adjustments based on the report of missing PDCCH receptions. For example, in addition to the information on the receive quality measurements, missing PDCCH statistics may be used to further adjust the DCI transmission pattern, one or more transmission characteristics (e.g., transmission power or beamforming parameters), or any combinations thereof.

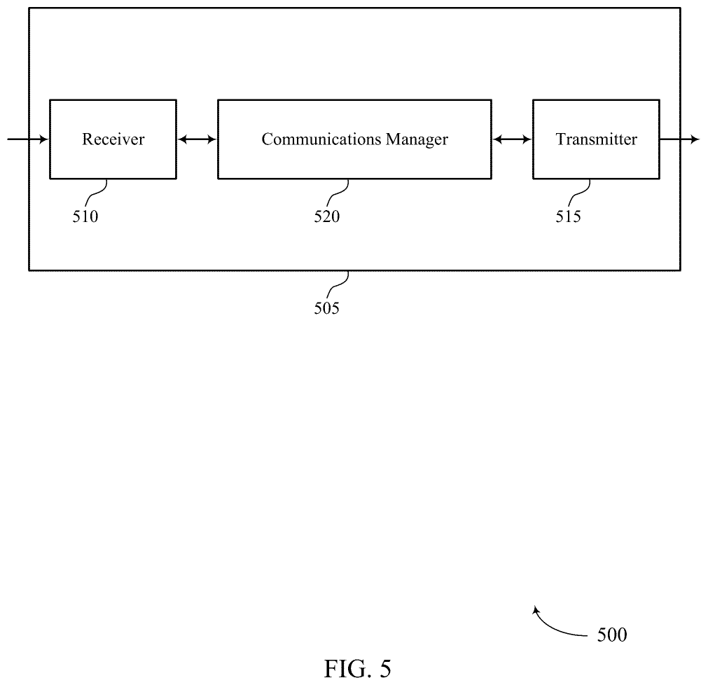

FIG. 5 shows a block diagram 500 of a device 505 that supports multiple carrier scheduling via single DCI transmissions in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to multiple carrier scheduling via single DCI transmissions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to multiple carrier scheduling via single DCI transmissions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of multiple carrier scheduling via single DCI transmissions as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The communications manager 520 is capable of, configured to, or operable to support a means for monitoring the one or more scheduling carriers of the set of multiple carriers for one or more repetitions of the single DCI communication in accordance with the carrier pattern. The communications manager 520 is capable of, configured to, or operable to support a means for receiving scheduling information for the set of multiple carriers in the single DCI communication.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for multiple carrier scheduling via single DCI transmissions, which may promote resource efficiency, reduced latency, and enhanced reliability.

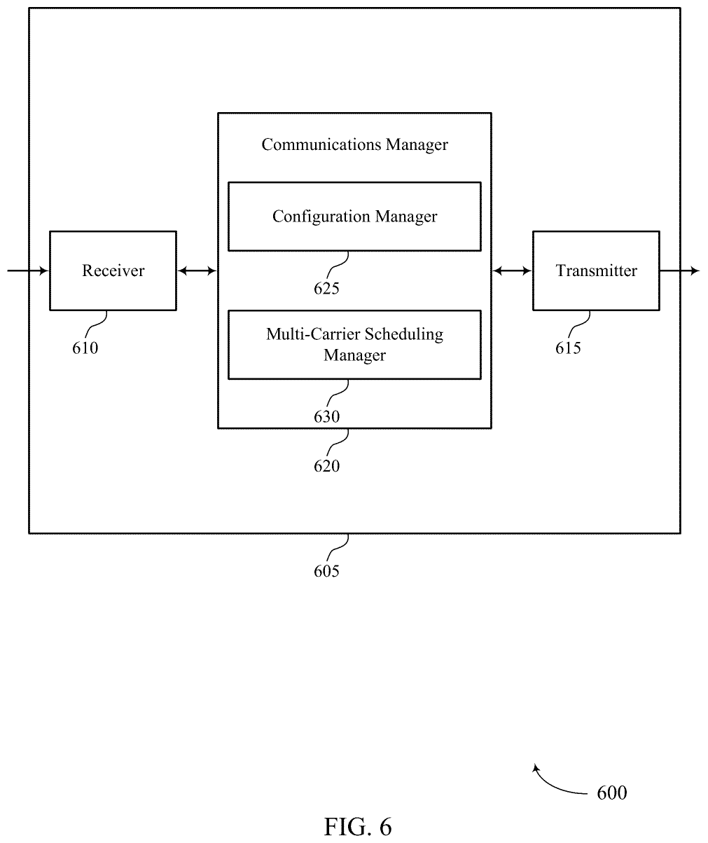

FIG. 6 shows a block diagram 600 of a device 605 that supports multiple carrier scheduling via single DCI transmissions in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to multiple carrier scheduling via single DCI transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multiple carrier scheduling via single DCI transmissions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of multiple carrier scheduling via single DCI transmissions as described herein. For example, the communications manager 620 may include a configuration manager 625 a multi-carrier scheduling manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration manager 625 is capable of, configured to, or operable to support a means for receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The multi-carrier scheduling manager 630 is capable of, configured to, or operable to support a means for monitoring the one or more scheduling carriers of the set of multiple carriers for one or more repetitions of the single DCI communication in accordance with the carrier pattern. The multi-carrier scheduling manager 630 is capable of, configured to, or operable to support a means for receiving scheduling information for the set of multiple carriers in the single DCI communication.

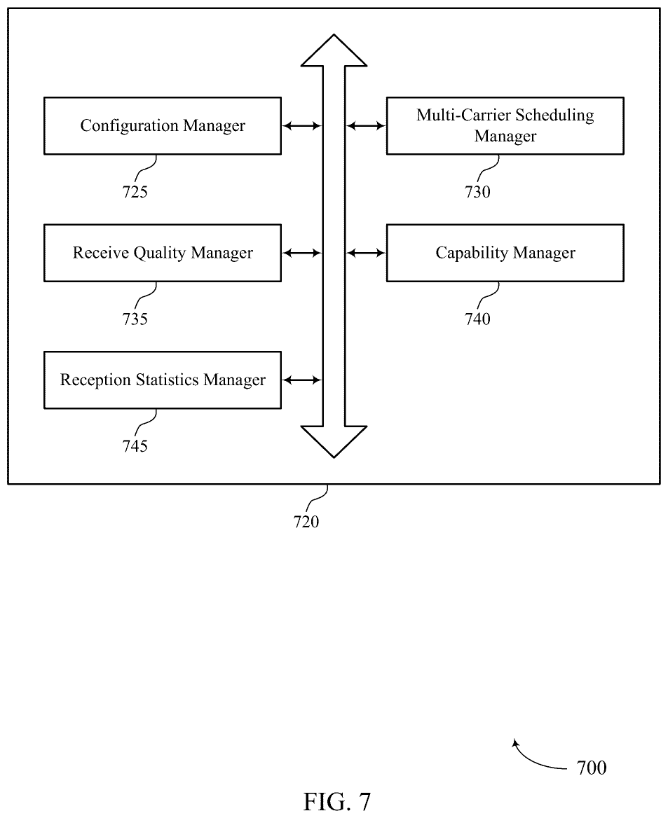

FIG. 7 shows a block diagram 700 of a communications manager 720 that supports multiple carrier scheduling via single DCI transmissions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of multiple carrier scheduling via single DCI transmissions as described herein. For example, the communications manager 720 may include a configuration manager 725, a multi-carrier scheduling manager 730, a receive quality manager 735, a capability manager 740, a reception statistics manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration manager 725 is capable of, configured to, or operable to support a means for receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The multi-carrier scheduling manager 730 is capable of, configured to, or operable to support a means for monitoring the one or more scheduling carriers of the set of multiple carriers for one or more repetitions of the single DCI communication in accordance with the carrier pattern. In some examples, the multi-carrier scheduling manager 730 is capable of, configured to, or operable to support a means for receiving scheduling information for the set of multiple carriers in the single DCI communication.

In some examples, the receive quality manager 735 is capable of, configured to, or operable to support a means for transmitting a receive scheduling control channel quality measurement and prediction for each carrier of the set of multiple carriers that indicates a channel quality associated with each respective carrier of the set of multiple carriers. In some examples, the receive scheduling control channel quality measurement and prediction for each carrier of the set of multiple carriers includes a probability of unsuccessful receipt of the single DCI communication at the UE for one or more control information (e.g., DCI) payload size ranges. In some examples, the receive scheduling control channel quality measurement and prediction for each carrier of the set of multiple carriers is transmitted via a scheduling control CSI report, a MAC-CE, or any combinations thereof.

In some examples, the multi-carrier scheduling manager 730 is capable of, configured to, or operable to support a means for receiving updated configuration information that updates the one or more scheduling carriers, the quantity of repetitions of the single DCI communication, a transmit power of the single DCI communication, one or more beamforming parameters used to transmit one or more repetitions of the single DCI communication, or any combinations thereof.

In some examples, the capability manager 740 is capable of, configured to, or operable to support a means for transmitting a capability indication that indicates that the UE is capable of receiving and predicting scheduling information receive performance for each carrier of the set of multiple carriers in the single DCI communication. In some examples, the capability indication provides separate indications for each of two or more frequency bands. In some examples, the carrier pattern indicates a quantity of repetitions of the single DCI communication for each carrier of the set of multiple carriers. In some examples, different carriers of the set of multiple carriers have different quantities of repetitions of the single DCI communication. In some examples, the carrier pattern further indicates two or more different downlink slots for two or more repetitions of the single DCI communication.

In some examples, the reception statistics manager 745 is capable of, configured to, or operable to support a means for transmitting a control channel reception statistics report that indicates a quality of control channel communications that have been received at the UE for each carrier of the set of multiple carriers. In some examples, the control channel reception statistics report is transmitted via a scheduling control CSI report, a MAC-CE, or any combinations thereof. In some examples, the reception statistics manager 745 is capable of, configured to, or operable to support a means predicting a control channel reception performance that indicates an expected quality of control channel communications for each carrier of the set of carriers.

In some examples, the multi-carrier scheduling manager 730 is capable of, configured to, or operable to support a means for receiving, responsive to the control channel reception statistics report, updated configuration information that updates the one or more scheduling carriers, the quantity of repetitions of the single DCI communication, a transmit power of the single DCI communication, one or more beamforming parameters used to transmit one or more repetitions of the single DCI communication, or any combinations thereof. In some examples, the one or more scheduling carriers are determined based on one or more reference signal transmissions from the UE, a discontinuous transmission (DTX) configuration of the UE, a block error rate for each carrier of the set of multiple carriers, or any combinations thereof.

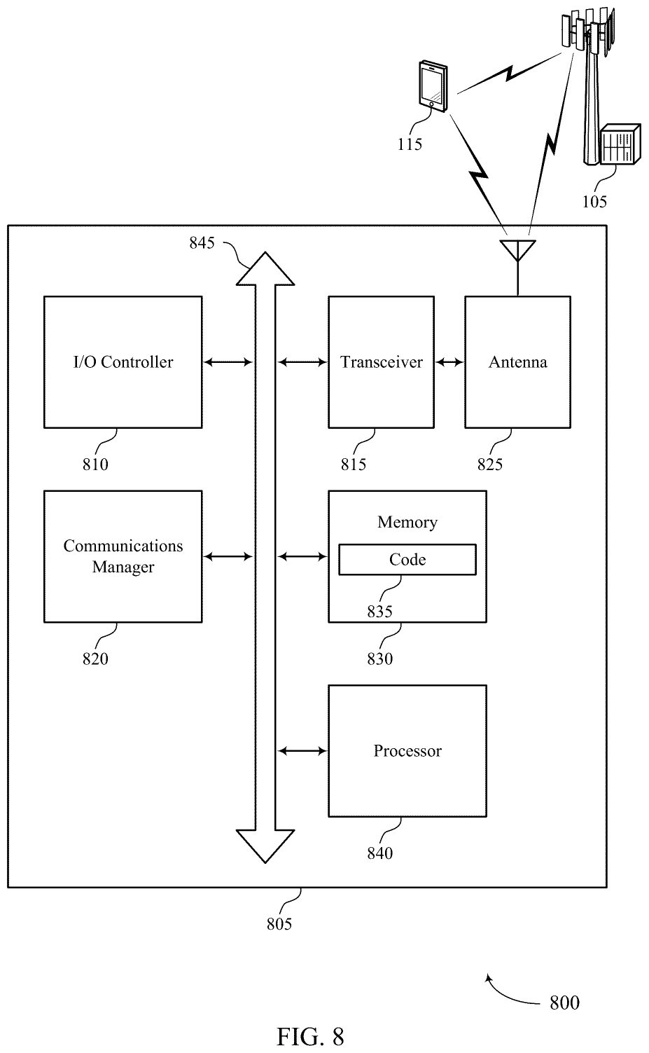

FIG. 8 shows a diagram of a system 800 including a device 805 that supports multiple carrier scheduling via single DCI transmissions in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting multiple carrier scheduling via single DCI transmissions). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The communications manager 820 is capable of, configured to, or operable to support a means for monitoring the one or more scheduling carriers of the set of multiple carriers for one or more repetitions of the single DCI communication in accordance with the carrier pattern. The communications manager 820 is capable of, configured to, or operable to support a means for receiving scheduling information for the set of multiple carriers in the single DCI communication.

By including or configuring the communications manager 820 in accordance with examples as described herein, the device 805 may support techniques for multiple carrier scheduling via single DCI transmissions, which may promote resource efficiency, reduced latency, and enhanced reliability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of multiple carrier scheduling via single DCI transmissions as described herein, or the at least one processor 840 and the at least one memory 830 may be otherwise configured to, individually or collectively, perform or support such operations.

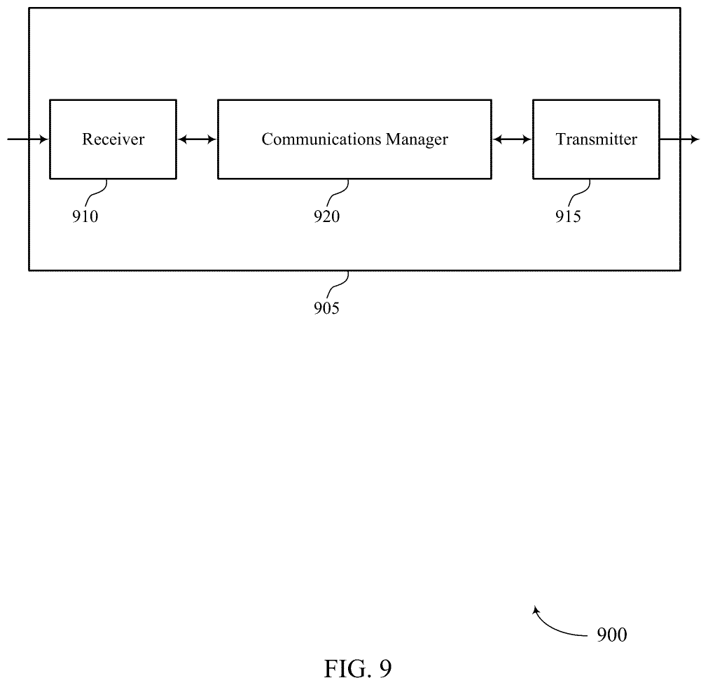

FIG. 9 shows a block diagram 900 of a device 905 that supports multiple carrier scheduling via single DCI transmissions in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of multiple carrier scheduling via single DCI transmissions as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting configuration information for a UE that configures a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The communications manager 920 is capable of, configured to, or operable to support a means for outputting one or more repetitions of the single DCI communication on the one or more scheduling carriers of the set of multiple carriers in accordance with the carrier pattern.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for multiple carrier scheduling via single DCI transmissions, which may promote resource efficiency, reduced latency, and enhanced reliability.

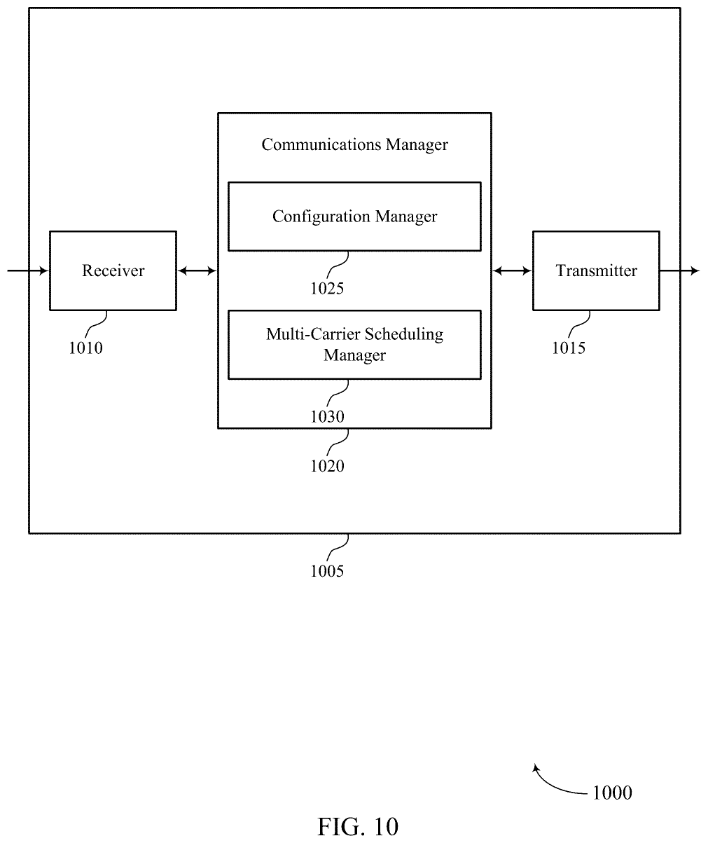

FIG. 10 shows a block diagram 1000 of a device 1005 that supports multiple carrier scheduling via single DCI transmissions in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of multiple carrier scheduling via single DCI transmissions as described herein. For example, the communications manager 1020 may include a configuration manager 1025 a multi-carrier scheduling manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration manager 1025 is capable of, configured to, or operable to support a means for outputting configuration information for a UE that configures a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The multi-carrier scheduling manager 1030 is capable of, configured to, or operable to support a means for outputting one or more repetitions of the single DCI communication on the one or more scheduling carriers of the set of multiple carriers in accordance with the carrier pattern.

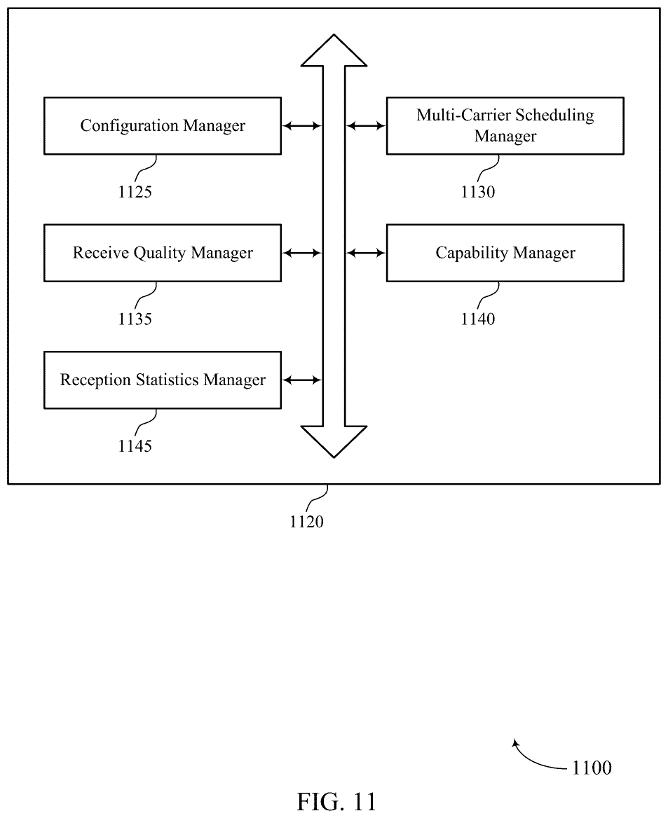

FIG. 11 shows a block diagram 1100 of a communications manager 1120 that supports multiple carrier scheduling via single DCI transmissions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of multiple carrier scheduling via single DCI transmissions as described herein. For example, the communications manager 1120 may include a configuration manager 1125, a multi-carrier scheduling manager 1130, a receive quality manager 1135, a capability manager 1140, a reception statistics manager 1145, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration manager 1125 is capable of, configured to, or operable to support a means for outputting configuration information for a UE that configures a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The multi-carrier scheduling manager 1130 is capable of, configured to, or operable to support a means for outputting one or more repetitions of the single DCI communication on the one or more scheduling carriers of the set of multiple carriers in accordance with the carrier pattern.

In some examples, the receive quality manager 1135 is capable of, configured to, or operable to support a means for obtaining, from the UE, a receive scheduling control channel quality measurement and prediction for each carrier of the set of multiple carriers that indicates a channel quality associated with each respective carrier of the set of multiple carriers. In some examples, the receive scheduling control channel quality measurement and prediction for each carrier of the set of multiple carriers includes a probability of unsuccessful receipt of the single DCI communication at the UE for one or more control information payload size ranges. In some examples, the receive quality scheduling control channel measurement for each carrier of the set of multiple carriers is transmitted via a scheduling control CSI report, a MAC-CE, or any combinations thereof.

In some examples, the multi-carrier scheduling manager 1130 is capable of, configured to, or operable to support a means for outputting updated configuration information that updates, based on the receive quality measurement for each carrier, the one or more scheduling carriers, the quantity of repetitions of the single DCI communication, a transmit power of one or more repetitions the single DCI communication, one or more beamforming parameters used to transmit one or more repetitions of the single DCI communication, or any combinations thereof.

In some examples, the capability manager 1140 is capable of, configured to, or operable to support a means for obtaining, from the UE, a capability indication that indicates that the UE is capable of receiving and predicting scheduling information receive performance for each carrier of the set of multiple carriers in the single DCI communication. In some examples, the capability indication provides separate indications for each of two or more frequency bands. In some examples, the carrier pattern indicates a quantity of repetitions of the single DCI communication for each carrier of the set of multiple carriers. In some examples, different carriers of the set of multiple carriers have different quantities of repetitions of the single DCI communication. In some examples, the carrier pattern further indicates two or more different downlink slots for two or more repetitions of the single DCI communication.

In some examples, the reception statistics manager 1145 is capable of, configured to, or operable to support a means for obtaining, from the UE, a control channel reception statistics report that indicates a quality of control channel communications that have been received at the UE for each carrier of the set of multiple carriers. In some examples, the control channel reception statistics report is transmitted via a scheduling control CSI report, a MAC-CE, or any combinations thereof.

In some examples, the multi-carrier scheduling manager 1130 is capable of, configured to, or operable to support a means for outputting, responsive to the control channel reception statistics report, updated configuration information that updates the one or more scheduling carriers, the quantity of repetitions of the single DCI communication, a transmit power of the single DCI communication, one or more beamforming parameters used to transmit one or more repetitions of the single DCI communication, or any combinations thereof. In some examples, the one or more scheduling carriers are determined based on one or more reference signal transmissions from the UE, a DTX configuration of the UE, a block error rate for each carrier of the set of multiple carriers, or any combinations thereof.

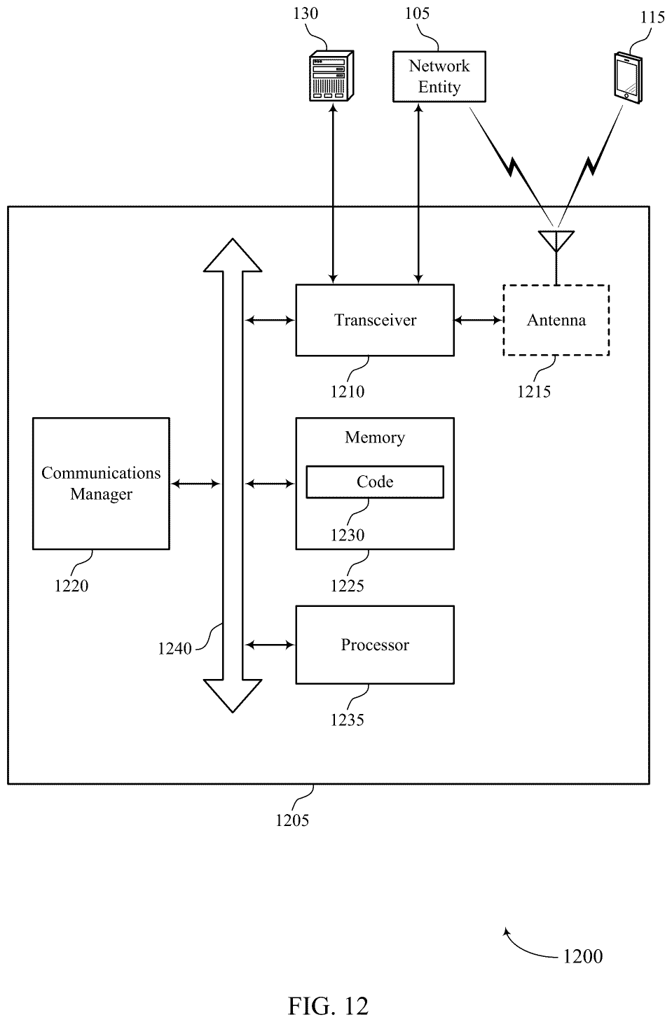

FIG. 12 shows a diagram of a system 1200 including a device 1205 that supports multiple carrier scheduling via single DCI transmissions in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting multiple carrier scheduling via single DCI transmissions). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting configuration information for a UE that configures a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The communications manager 1220 is capable of, configured to, or operable to support a means for outputting one or more repetitions of the single DCI communication on the one or more scheduling carriers of the set of multiple carriers in accordance with the carrier pattern.

By including or configuring the communications manager 1220 in accordance with examples as described herein, the device 1205 may support techniques for multiple carrier scheduling via single DCI transmissions, which may promote resource efficiency, reduced latency, and enhanced reliability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of multiple carrier scheduling via single DCI transmissions as described herein, or the at least one processor 1235 and the at least one memory 1225 may be otherwise configured to, individually or collectively, perform or support such operations.

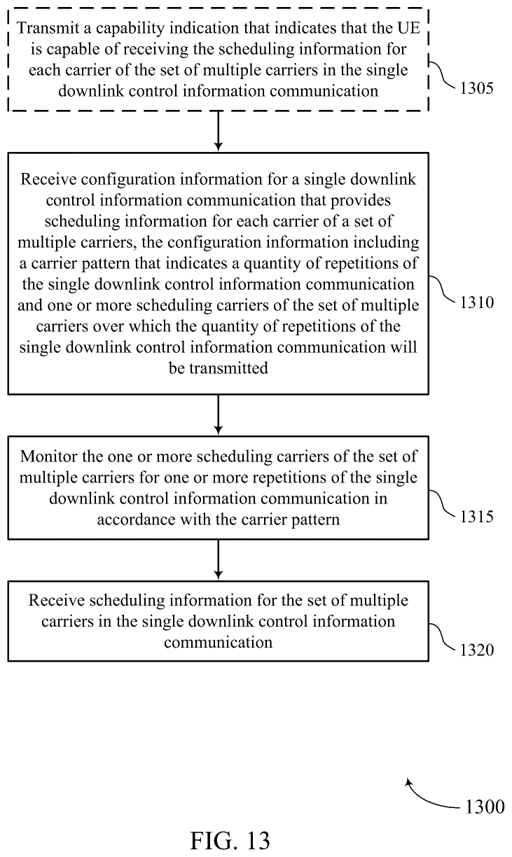

FIG. 13 shows a flowchart illustrating a method 1300 that supports multiple carrier scheduling via single DCI transmissions in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

Optionally, at 1305, the method may include transmitting a capability indication that indicates that the UE is capable of receiving and predicting scheduling information receive performance for each carrier of the set of multiple carriers in the single DCI communication. The operations of block 1305 may be performed in accordance with examples as disclosed herein. In some examples, aspects of the operations of 1305 may be performed by a capability manager 740 as described with reference to FIG. 7.

At 1310, the method may include receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The operations of block 1310 may be performed in accordance with examples as disclosed herein. In some examples, aspects of the operations of 1310 may be performed by a configuration manager 725 as described with reference to FIG. 7.

At 1315, the method may include monitoring the one or more scheduling carriers of the set of multiple carriers for one or more repetitions of the single DCI communication in accordance with the carrier pattern. The operations of block 1315 may be performed in accordance with examples as disclosed herein. In some examples, aspects of the operations of 1315 may be performed by a multi-carrier scheduling manager 730 as described with reference to FIG. 7.

At 1320, the method may include receiving scheduling information for the set of multiple carriers in the single DCI communication. The operations of block 1320 may be performed in accordance with examples as disclosed herein. In some examples, aspects of the operations of 1320 may be performed by a multi-carrier scheduling manager 730 as described with reference to FIG. 7.

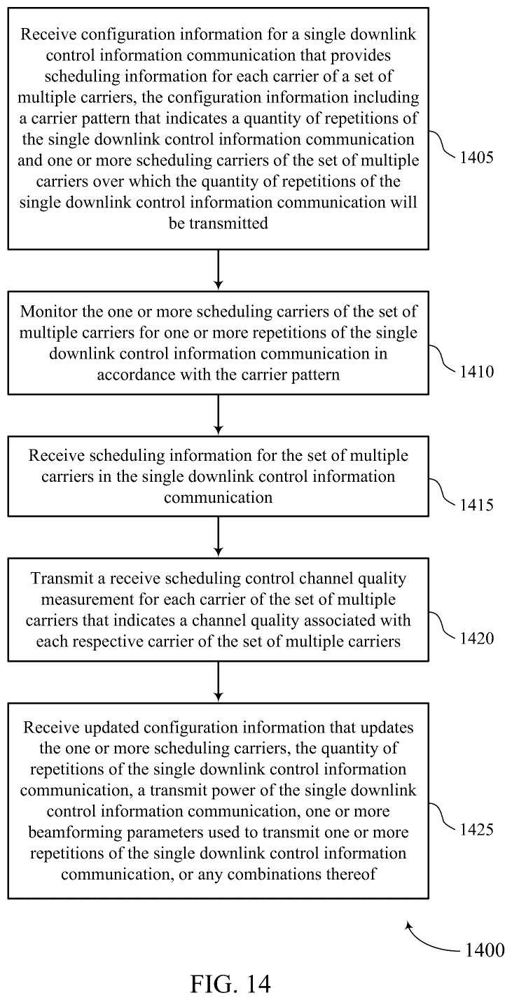

FIG. 14 shows a flowchart illustrating a method 1400 that supports multiple carrier scheduling via single DCI transmissions in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The operations of block 1405 may be performed in accordance with examples as disclosed herein. In some examples, aspects of the operations of 1405 may be performed by a configuration manager 725 as described with reference to FIG. 7.

At 1410, the method may include monitoring the one or more scheduling carriers of the set of multiple carriers for one or more repetitions of the single DCI communication in accordance with the carrier pattern. The operations of block 1410 may be performed in accordance with examples as disclosed herein. In some examples, aspects of the operations of 1410 may be performed by a multi-carrier scheduling manager 730 as described with reference to FIG. 7.

At 1415, the method may include receiving scheduling information for the set of multiple carriers in the single DCI communication. The operations of block 1415 may be performed in accordance with examples as disclosed herein. In some examples, aspects of the operations of 1415 may be performed by a multi-carrier scheduling manager 730 as described with reference to FIG. 7.

At 1420, the method may include transmitting a receive scheduling control channel quality measurement and prediction for each carrier of the set of multiple carriers that indicates a channel quality associated with each respective carrier of the set of multiple carriers. The operations of block 1420 may be performed in accordance with examples as disclosed herein. In some examples, aspects of the operations of 1420 may be performed by a receive quality manager 735 as described with reference to FIG. 7.

At 1425, the method may include receiving updated configuration information that updates the one or more scheduling carriers, the quantity of repetitions of the single DCI communication, a transmit power of the single DCI communication, one or more beamforming parameters used to transmit one or more repetitions of the single DCI communication, or any combinations thereof. The operations of block 1425 may be performed in accordance with examples as disclosed herein. In some examples, aspects of the operations of 1425 may be performed by a multi-carrier scheduling manager 730 as described with reference to FIG. 7.

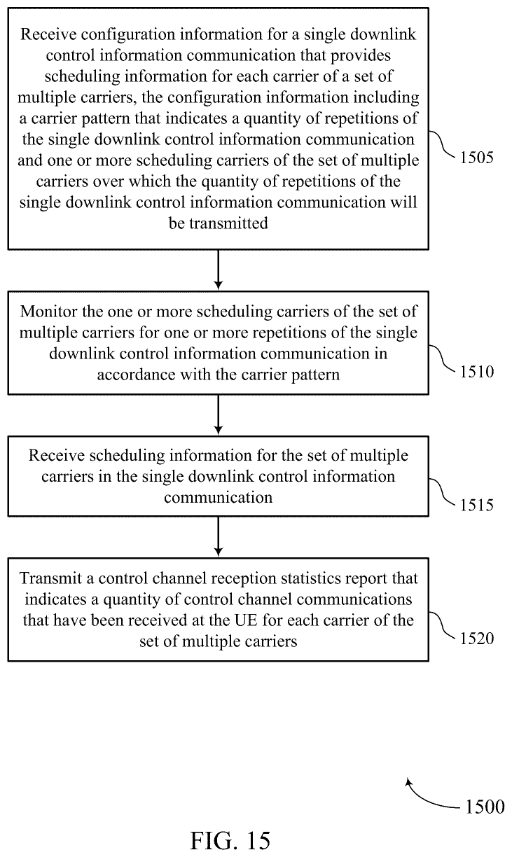

FIG. 15 shows a flowchart illustrating a method 1500 that supports multiple carrier scheduling via single DCI transmissions in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The operations of block 1505 may be performed in accordance with examples as disclosed herein. In some examples, aspects of the operations of 1505 may be performed by a configuration manager 725 as described with reference to FIG. 7.

At 1510, the method may include monitoring the one or more scheduling carriers of the set of multiple carriers for one or more repetitions of the single DCI communication in accordance with the carrier pattern. The operations of block 1510 may be performed in accordance with examples as disclosed herein. In some examples, aspects of the operations of 1510 may be performed by a multi-carrier scheduling manager 730 as described with reference to FIG. 7.

At 1515, the method may include receiving scheduling information for the set of multiple carriers in the single DCI communication. The operations of block 1515 may be performed in accordance with examples as disclosed herein. In some examples, aspects of the operations of 1515 may be performed by a multi-carrier scheduling manager 730 as described with reference to FIG. 7.

At 1520, the method may include transmitting a control channel reception statistics report that indicates a quality of control channel communications that have been received at the UE for each carrier of the set of multiple carriers. The operations of block 1520 may be performed in accordance with examples as disclosed herein. In some examples, aspects of the operations of 1520 may be performed by a reception statistics manager 745 as described with reference to FIG. 7.

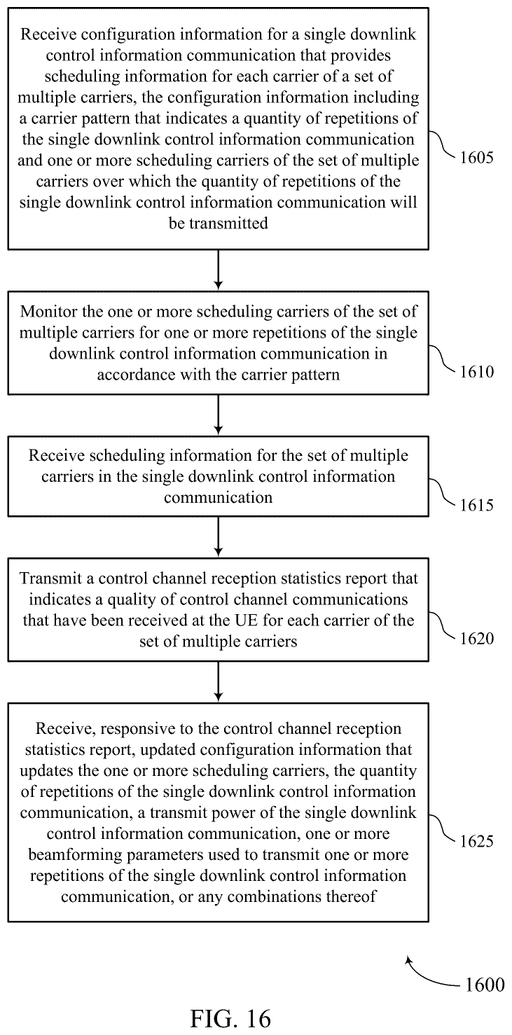

FIG. 16 shows a flowchart illustrating a method 1600 that supports multiple carrier scheduling via single DCI transmissions in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include receiving configuration information for a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The operations of block 1605 may be performed in accordance with examples as disclosed herein. In some examples, aspects of the operations of 1605 may be performed by a configuration manager 725 as described with reference to FIG. 7.

At 1610, the method may include monitoring the one or more scheduling carriers of the set of multiple carriers for one or more repetitions of the single DCI communication in accordance with the carrier pattern. The operations of block 1610 may be performed in accordance with examples as disclosed herein. In some examples, aspects of the operations of 1610 may be performed by a multi-carrier scheduling manager 730 as described with reference to FIG. 7.

At 1615, the method may include receiving scheduling information for the set of multiple carriers in the single DCI communication. The operations of block 1615 may be performed in accordance with examples as disclosed herein. In some examples, aspects of the operations of 1615 may be performed by a multi-carrier scheduling manager 730 as described with reference to FIG. 7.

At 1620, the method may include transmitting a control channel reception statistics report that indicates a quality of control channel communications that have been received at the UE for each carrier of the set of multiple carriers. The operations of block 1620 may be performed in accordance with examples as disclosed herein. In some examples, aspects of the operations of 1620 may be performed by a reception statistics manager 745 as described with reference to FIG. 7.

At 1625, the method may include receiving, responsive to the control channel reception statistics report, updated configuration information that updates the one or more scheduling carriers, the quantity of repetitions of the single DCI communication, a transmit power of the single DCI communication, one or more beamforming parameters used to transmit one or more repetitions of the single DCI communication, or any combinations thereof. The operations of block 1625 may be performed in accordance with examples as disclosed herein. In some examples, aspects of the operations of 1625 may be performed by a multi-carrier scheduling manager 730 as described with reference to FIG. 7.

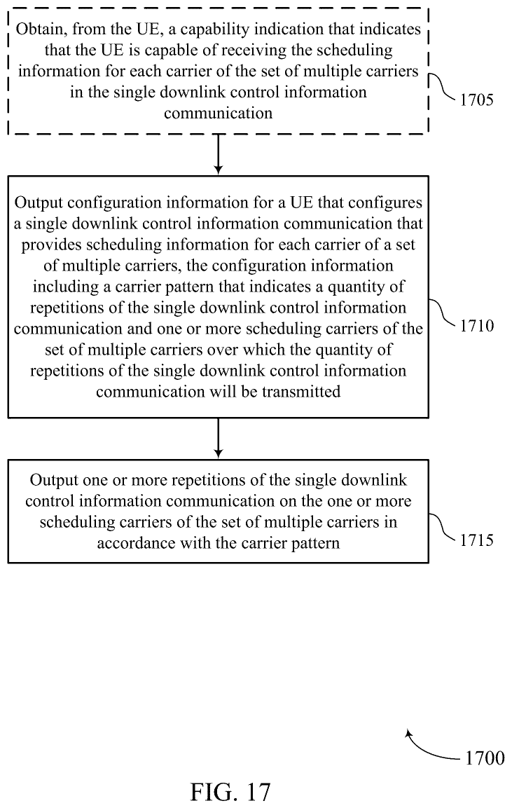

FIG. 17 shows a flowchart illustrating a method 1700 that supports multiple carrier scheduling via single DCI transmissions in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

Optionally, at 1705, the method may include obtaining, from the UE, a capability indication that indicates that the UE is capable of receiving and predicting scheduling information receive performance for each carrier of the set of multiple carriers in the single DCI communication. The operations of block 1705 may be performed in accordance with examples as disclosed herein. In some examples, aspects of the operations of 1705 may be performed by a capability manager 1140 as described with reference to FIG. 11.

At 1710, the method may include outputting configuration information for a UE that configures a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The operations of block 1710 may be performed in accordance with examples as disclosed herein. In some examples, aspects of the operations of 1710 may be performed by a configuration manager 1125 as described with reference to FIG. 11.

At 1715, the method may include outputting one or more repetitions of the single DCI communication on the one or more scheduling carriers of the set of multiple carriers in accordance with the carrier pattern. The operations of block 1715 may be performed in accordance with examples as disclosed herein. In some examples, aspects of the operations of 1715 may be performed by a multi-carrier scheduling manager 1130 as described with reference to FIG. 11.

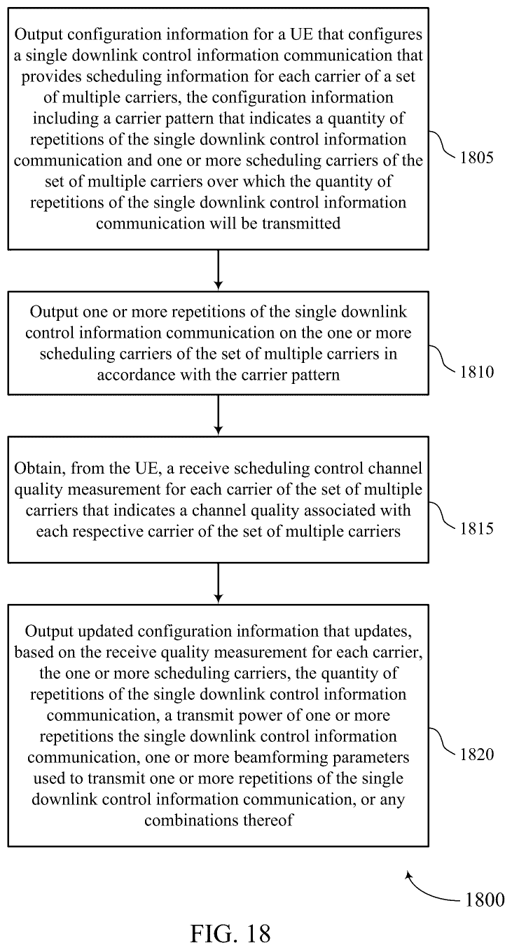

FIG. 18 shows a flowchart illustrating a method 1800 that supports multiple carrier scheduling via single DCI transmissions in accordance with aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include outputting configuration information for a UE that configures a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The operations of block 1805 may be performed in accordance with examples as disclosed herein. In some examples, aspects of the operations of 1805 may be performed by a configuration manager 1125 as described with reference to FIG. 11.

At 1810, the method may include outputting one or more repetitions of the single DCI communication on the one or more scheduling carriers of the set of multiple carriers in accordance with the carrier pattern. The operations of block 1810 may be performed in accordance with examples as disclosed herein. In some examples, aspects of the operations of 1810 may be performed by a multi-carrier scheduling manager 1130 as described with reference to FIG. 11.

At 1815, the method may include obtaining, from the UE, a receive scheduling control channel quality measurement and prediction for each carrier of the set of multiple carriers that indicates a channel quality associated with each respective carrier of the set of multiple carriers. The operations of block 1815 may be performed in accordance with examples as disclosed herein. In some examples, aspects of the operations of 1815 may be performed by a receive quality manager 1135 as described with reference to FIG. 11.

At 1820, the method may include outputting updated configuration information that updates, based on the receive quality measurement for each carrier, the one or more scheduling carriers, the quantity of repetitions of the single DCI communication, a transmit power of one or more repetitions the single DCI communication, one or more beamforming parameters used to transmit one or more repetitions of the single DCI communication, or any combinations thereof. The operations of block 1820 may be performed in accordance with examples as disclosed herein. In some examples, aspects of the operations of 1820 may be performed by a multi-carrier scheduling manager 1130 as described with reference to FIG. 11.

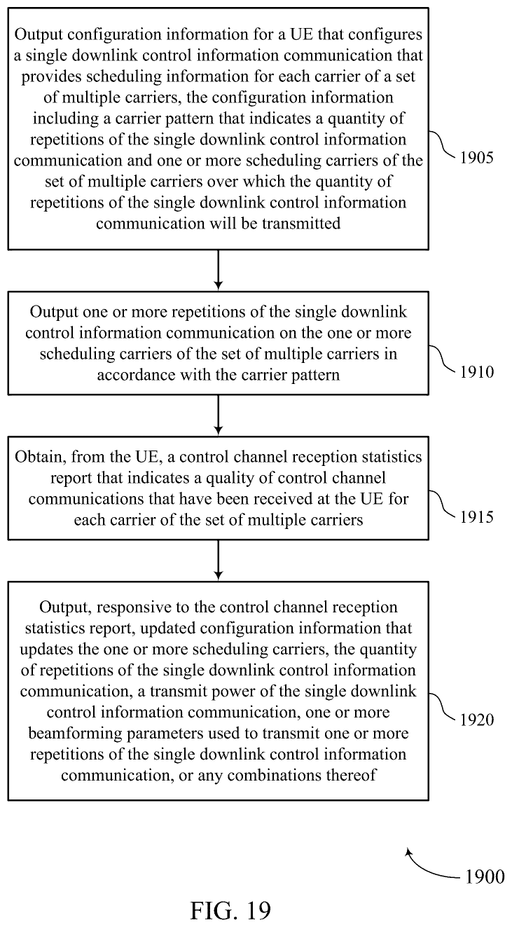

FIG. 19 shows a flowchart illustrating a method 1900 that supports multiple carrier scheduling via single DCI transmissions in accordance with aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include outputting configuration information for a UE that configures a single DCI communication that provides scheduling information for each carrier of a set of multiple carriers, the configuration information including a carrier pattern that indicates a quantity of repetitions of the single DCI communication and one or more scheduling carriers of the set of multiple carriers over which the quantity of repetitions of the single DCI communication will be transmitted. The operations of block 1905 may be performed in accordance with examples as disclosed herein. In some examples, aspects of the operations of 1905 may be performed by a configuration manager 1125 as described with reference to FIG. 11.

At 1910, the method may include outputting one or more repetitions of the single DCI communication on the one or more scheduling carriers of the set of multiple carriers in accordance with the carrier pattern. The operations of block 1910 may be performed in accordance with examples as disclosed herein. In some examples, aspects of the operations of 1910 may be performed by a multi-carrier scheduling manager 1130 as described with reference to FIG. 11.

At 1915, the method may include obtaining, from the UE, a control channel reception statistics report that indicates a quality of control channel communications that have been received at the UE for each carrier of the set of multiple carriers. The operations of block 1915 may be performed in accordance with examples as disclosed herein. In some examples, aspects of the operations of 1915 may be performed by a reception statistics manager 1145 as described with reference to FIG. 11.

At 1920, the method may include outputting, responsive to the control channel reception statistics report, updated configuration information that updates the one or more scheduling carriers, the quantity of repetitions of the single DCI communication, a transmit power of the single DCI communication, one or more beamforming parameters used to transmit one or more repetitions of the single DCI communication, or any combinations thereof. The operations of block 1920 may be performed in accordance with examples as disclosed herein. In some examples, aspects of the operations of 1920 may be performed by a multi-carrier scheduling manager 1130 as described with reference to FIG. 11.

The following provides an overview of aspects of the present disclosure:
Aspect 1: A method for wireless communications at a UE, comprising: receiving configuration information for a single downlink control information communication that provides scheduling information for each carrier of a plurality of carriers, the configuration information including a carrier pattern that indicates a quantity of repetitions of the single downlink control information communication and one or more scheduling carriers of the plurality of carriers over which the quantity of repetitions of the single downlink control information communication will be transmitted; monitoring the one or more scheduling carriers of the plurality of carriers for one or more repetitions of the single downlink control information communication in accordance with the carrier pattern; and receiving scheduling information for the plurality of carriers in the single downlink control information communication.
Aspect 2: The method of aspect 1, further comprising: transmitting a receive scheduling control channel quality measurement and prediction for each carrier of the plurality of carriers that indicates a channel quality associated with each respective carrier of the plurality of carriers.
Aspect 3: The method of aspect 2, wherein the receive scheduling control channel quality measurement and prediction for each carrier of the plurality of carriers includes a probability of unsuccessful receipt of the single downlink control information communication at the UE for one or more control information payload size ranges.
Aspect 4: The method of any of aspects 2 through 3, wherein the receive scheduling control channel quality measurement and prediction for each carrier of the plurality of carriers is transmitted via a scheduling control CSI report, a MAC-CE, or any combinations thereof.
Aspect 5: The method of any of aspects 2 through 4, further comprising: receiving updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.
Aspect 6: The method of any of aspects 1 through 5, further comprising: transmitting a capability indication that indicates that the UE is capable of receiving and predicting scheduling information receive performance for each carrier of the plurality of carriers in the single downlink control information communication.
Aspect 7: The method of aspect 6, wherein the capability indication provides separate indications for each of two or more frequency bands.
Aspect 8: The method of any of aspects 1 through 7, wherein the carrier pattern indicates a quantity of repetitions of the single downlink control information communication for each carrier of the plurality of carriers.
Aspect 9: The method of aspect 8, wherein different carriers of the plurality of carriers have different quantities of repetitions of the single downlink control information communication.
Aspect 10: The method of any of aspects 8 through 9, wherein the carrier pattern further indicates two or more different downlink slots for two or more repetitions of the single downlink control information communication.
Aspect 11: The method of any of aspects 1 through 10, further comprising: transmitting a control channel reception statistics report that indicates a quality of control channel communications that have been received at the UE for each carrier of the plurality of carriers.
Aspect 12: The method of aspect 11, wherein the control channel reception statistics report is transmitted via a scheduling control CSI report, a MAC-CE, or any combinations thereof.
Aspect 13: The method of any of aspects 11 through 12, further comprising: receiving, responsive to the control channel reception statistics report, updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.
Aspect 14: The method of any of aspects 1 through 13, wherein the one or more scheduling carriers are determined based at least in part on one or more reference signal transmissions from the UE, a DTX configuration of the UE, a block error rate for each carrier of the plurality of carriers, or any combinations thereof.
Aspect 15: A method for wireless communications at a network entity, comprising: outputting configuration information for a UE that configures a single downlink control information communication that provides scheduling information for each carrier of a plurality of carriers, the configuration information including a carrier pattern that indicates a quantity of repetitions of the single downlink control information communication and one or more scheduling carriers of the plurality of carriers over which the quantity of repetitions of the single downlink control information communication will be transmitted; and outputting one or more repetitions of the single downlink control information communication on the one or more scheduling carriers of the plurality of carriers in accordance with the carrier pattern.
Aspect 16: The method of aspect 15, further comprising: obtaining, from the UE, a receive scheduling control channel quality measurement and prediction for each carrier of the plurality of carriers that indicates a channel quality associated with each respective carrier of the plurality of carriers.
Aspect 17: The method of aspect 16, wherein the receive scheduling control channel quality measurement and prediction for each carrier of the plurality of carriers includes a probability of unsuccessful receipt of the single downlink control information communication at the UE for one or more control information payload size ranges.
Aspect 18: The method of any of aspects 16 through 17, wherein the receive quality scheduling control channel measurement for each carrier of the plurality of carriers is transmitted via a scheduling control CSI report, a MAC-CE, or any combinations thereof.
Aspect 19: The method of any of aspects 16 through 18, further comprising: outputting updated configuration information that updates, based at least in part on the receive quality measurement for each carrier, the one or more scheduling carriers, the quantity of repetitions of the single downlink control information communication, a transmit power of one or more repetitions the single downlink control information communication, one or more beamforming parameters used to transmit one or more repetitions of the single downlink control information communication, or any combinations thereof.
Aspect 20: The method of any of aspects 15 through 19, further comprising: obtaining, from the UE, a capability indication that indicates that the UE is capable of receiving and predicting scheduling information receive performance for each carrier of the plurality of carriers in the single downlink control information communication.
Aspect 21: The method of aspect 20, wherein the capability indication provides separate indications for each of two or more frequency bands.
Aspect 22: The method of any of aspects 15 through 21, wherein the carrier pattern indicates a quantity of repetitions of the single downlink control information communication for each carrier of the plurality of carriers.
Aspect 23: The method of aspect 22, wherein different carriers of the plurality of carriers have different quantities of repetitions of the single downlink control information communication.
Aspect 24: The method of any of aspects 22 through 23, wherein the carrier pattern further indicates two or more different downlink slots for two or more repetitions of the single downlink control information communication.
Aspect 25: The method of any of aspects 15 through 24, further comprising: obtaining, from the UE, a control channel reception statistics report that indicates a quality of control channel communications that have been received at the UE for each carrier of the plurality of carriers.
Aspect 26: The method of aspect 25, wherein the control channel reception statistics report is transmitted via a scheduling control CSI report, a medium access control (MAC) control element, or any combinations thereof.
Aspect 27: The method of any of aspects 25 through 26, further comprising: outputting, responsive to the control channel reception statistics report, updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.
Aspect 28: The method of any of aspects 15 through 27, wherein the one or more scheduling carriers are determined based at least in part on one or more reference signal transmissions from the UE, a DTX configuration of the UE, a block error rate for each carrier of the plurality of carriers, or any combinations thereof.
Aspect 29: A UE for wireless communications, comprising one or more memories storing processor-executable code, and one or more processors coupled with the one or more memories and individually or collectively operable to execute the code to cause the UE to perform a method of any of aspects 1 through 14.
Aspect 30: A UE for wireless communications, comprising at least one means for performing a method of any of aspects 1 through 14.
Aspect 31: A non-transitory computer-readable medium storing code for wireless communications, the code comprising instructions executable by one or more processors to perform a method of any of aspects 1 through 14.
Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.
Aspect 33: A network entity for wireless communications, comprising at least one means for performing a method of any of aspects 15 through 28.
Aspect 34: A non-transitory computer-readable medium storing code for wireless communications, the code comprising instructions executable by one or more processors to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information for a single downlink control information communication that provides scheduling information for each carrier of a plurality of carriers, the configuration information including a carrier pattern that indicates a quantity of repetitions of the single downlink control information communication and one or more scheduling carriers of the plurality of carriers over which the quantity of repetitions of the single downlink control information communication will be transmitted;
monitor the one or more scheduling carriers of the plurality of carriers for one or more repetitions of the single downlink control information communication in accordance with the carrier pattern; and
receive scheduling information for the plurality of carriers in the single downlink control information communication.

2. The UE of claim 1, wherein the one or more processors are individually or collectively further operable to execute the code to cause the UE to:
transmit a receive scheduling control channel quality measurement and prediction for each carrier of the plurality of carriers that indicates a channel quality associated with each respective carrier of the plurality of carriers.

3. The UE of claim 2, wherein the receive scheduling control channel quality measurement and prediction for each carrier of the plurality of carriers includes a probability of unsuccessful receipt of the single downlink control information communication at the UE for one or more control information payload size ranges.

4. The UE of claim 2, wherein the receive scheduling control channel quality measurement and prediction for each carrier of the plurality of carriers is transmitted via a scheduling control channel state information (CSI) report, a medium access control (MAC) control element, or any combinations thereof.

5. The UE of claim 2, wherein the one or more processors are individually or collectively further operable to execute the code to cause the UE to:
receive updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.

6. The UE of claim 1, wherein the one or more processors are individually or collectively further operable to execute the code to cause the UE to:
transmit a capability indication that indicates that the UE is capable of receiving and predicting scheduling information receive performance for each carrier of the plurality of carriers in the single downlink control information communication.

7. The UE of claim 6, wherein the capability indication provides separate indications for each of two or more frequency bands.

8. The UE of claim 1, wherein the carrier pattern indicates a quantity of repetitions of the single downlink control information communication for each carrier of the plurality of carriers.

9. The UE of claim 8, wherein different carriers of the plurality of carriers have different quantities of repetitions of the single downlink control information communication.

10. The UE of claim 8, wherein the carrier pattern further indicates two or more different downlink slots for two or more repetitions of the single downlink control information communication.

11. The UE of claim 1, wherein the one or more processors are individually or collectively further operable to execute the code to cause the UE to:
transmit a control channel reception statistics report that indicates a quality of control channel communications that have been received at the UE for each carrier of the plurality of carriers.

12. The UE of claim 1, wherein the one or more processors are individually or collectively further operable to execute the code to cause the UE to:
predict a control channel reception performance that indicates an expected quality of control channel communications for each carrier of the plurality of carriers.

13. The UE of claim 11, wherein the control channel reception statistics report is transmitted via a scheduling control channel state information (CSI) report, a medium access control (MAC) control element, or any combinations thereof.

14. The UE of claim 11, wherein the one or more processors are individually or collectively further operable to execute the code to cause the UE to:
receive, responsive to the control channel reception statistics report, updated configuration information that updates the one or more scheduling carriers, the quantity of repetitions of the single downlink control information communication, a transmit power of the single downlink control information communication, one or more beamforming parameters used to transmit one or more repetitions of the single downlink control information communication, or any combinations thereof.

15. A method for wireless communications at a user equipment (UE), comprising:
receiving configuration information for a single downlink control information communication that provides scheduling information for each carrier of a plurality of carriers, the configuration information including a carrier pattern that indicates a quantity of repetitions of the single downlink control information communication and one or more scheduling carriers of the plurality of carriers over which the quantity of repetitions of the single downlink control information communication will be transmitted;
monitoring the one or more scheduling carriers of the plurality of carriers for one or more repetitions of the single downlink control information communication in accordance with the carrier pattern; and
receiving scheduling information for the plurality of carriers in the single downlink control information communication.

16. The method of claim 15, further comprising:
transmitting a receive scheduling control channel quality measurement and prediction for each carrier of the plurality of carriers that indicates a channel quality associated with each respective carrier of the plurality of carriers.

17. The method of claim 16, wherein the receive scheduling control channel quality measurement and prediction for each carrier of the plurality of carriers includes a probability of unsuccessful receipt of the single downlink control information communication at the UE for one or more control information payload size ranges.

18. A user equipment (UE) for wireless communications, comprising:
means for receiving configuration information for a single downlink control information communication that provides scheduling information for each carrier of a plurality of carriers, the configuration information including a carrier pattern that indicates a quantity of repetitions of the single downlink control information communication and one or more scheduling carriers of the plurality of carriers over which the quantity of repetitions of the single downlink control information communication will be transmitted;
means for monitoring the one or more scheduling carriers of the plurality of carriers for one or more repetitions of the single downlink control information communication in accordance with the carrier pattern; and
means for receiving scheduling information for the plurality of carriers in the single downlink control information communication.

19. The UE of claim 18, further comprising:
means for transmitting a capability indication that indicates that the UE is capable of receiving and predicting scheduling information receive performance for each carrier of the plurality of carriers in the single downlink control information communication.

20. The UE of claim 18, wherein the carrier pattern indicates a quantity of repetitions of the single downlink control information communication for each carrier of the plurality of carriers.
